(19) United States
(12) Patent Application Publication
(10) Pub. No.: US 2026/0127209 A1
(43) Pub. Date: May 7, 2026

(54) PROCESS AND SYSTEM FOR SECURELY SEARCHING AND SUMMARIZING DATA FROM SOURCE SYSTEMS

(71) Applicant: Chevron U.S.A. Inc., San Ramon, CA (US)

(72) Inventors: Amitkumar C. Jain, Katy, TX (US); Binh Vu, Missouri City, TX (US)

(21) Appl. No.: 19/372,258

(22) Filed: Oct. 28, 2025

Related U.S. Application Data
(60) Provisional application No. 63/716,797, filed on Nov. 6, 2024.

(51) Int. Cl. G06F 16/34; G06F 16/215; G06F 16/332; G06F 16/334; G06F 21/62

(52) U.S. Cl. CPC G06F 16/345; G06F 16/215; G06F 16/3325; G06F 16/334; G06F 21/6218; G06F 2221/2141

(57) ABSTRACT

A system and process is described for securely searching and summarizing results from organizational source systems. The system and process retrieves live data from multiple disparate systems of record using a retrieval-augmented generation (RAG) approach, AI agents, and an AI Assistant Orchestrator. The AI Assistant Orchestrator is aware of all of capabilities of the AI agents and the systems of record including security, data structures, and communication protocols, and automatically generates requests for the AI agents and queries for the systems of record in their respective correct format and execution order including adaptive calls based on information for preceding request or execution steps. The method also correlates data identities between the systems of record and the AI agents using dynamically generated harmonization steps with generative AI to obtain retrieved data and correlated information; and provides the retrieved data and the correlated information to the operator.

### CROSS-REFERENCE TO RELATED APPLICATIONS

This application claims the benefit of U.S. Provisional Application 63/716,797 filed Nov. 6, 2024.

### TECHNICAL FIELD

The disclosed embodiments relate generally to techniques for accessing data from source systems using artificial intelligence while maintaining security for the data.

### BACKGROUND

Many companies would like to enable their employees to easily access data from source systems within the company using artificial intelligence (AI) such as large language models (LLMs) while ensuring that the employees can only receive answers that they are permitted to see and while preventing the company data from being added to the corpus used for training the LLM. This is complicated due to the great variety in query formatting and data structure of the different systems of record used. There exists a need for this ability to easily and securely search disparate systems of record and receive the requested data that the user is permitted to access.

### SUMMARY

In accordance with some embodiments, a method of securely searching and summarizing results from multiple organizational source systems is disclosed. The method receives input from an operator, then based on the input from the operator, retrieves live data from multiple disparate systems of record using a retrieval-augmented generation (RAG) approach, AI agents, and an AI Assistant Orchestrator. The AI Assistant Orchestrator is aware of all of capabilities of the AI agents and the multiple disparate systems of record including security, data structures, and communication protocols, and the AI Assistant Orchestrator automatically generates requests for the AI agents and queries for the multiple disparate systems of record in their respective correct format and execution order including adaptive calls based on information for preceding request or execution steps. The method also correlates data identities between the multiple disparate systems of record and the AI agents using dynamically generated harmonization steps with generative AI to obtain retrieved data and correlated information; and provides the retrieved data and the correlated information to the operator.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for a digital AI Assistant; and

FIG. 2 demonstrates a process flow for natural language and query language processing.

Like reference numerals refer to corresponding parts throughout the drawings.

### DETAILED DESCRIPTION OF EMBODIMENTS

Described below are methods, systems, and computer readable storage media that provide a manner of securely searching and summarizing results from organizational source systems, including sending instructions to be executed by the source systems in order to retrieve the requested data. These embodiments are designed to be of particular use for making enterprise engineering information and facility-specific engineering and operational information accessible to end users using a chat feature in a communications platform such as Microsoft Teams.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

The Digital AI Assistant aims to enhance enterprise content search by utilizing natural language processing. This means operators can interact with the system using everyday language rather than complex queries. The Digital AI Assistant can process both structured (organized) and unstructured (free-form) content, offering search results in a range of formats, from raw data to more concise, context-rich summaries tailored to different user personas (roles). This Digital AI Assistant can seamlessly integrate into specific applications, such as Teams, Digital Twins, and the like, offering a user-friendly and intuitive way for enterprise users to directly search various source systems. Any user interface may be used.

This integration is sometimes referred to as a “copilot”feature and is a generative AI.

The system described herein may be of use for any type of operations wherein an operator or user needs to be able to make a request for data from more than one, potentially very different, system of record. A particular embodiment may describe a system for facilitating oil and gas processing plant operations. In general terms, the system may:
Obtain live operational data from multiple disparate systems of record (by way of example and not limitation, operational data within an oil and gas processing plant)
Implement a Retrieval-Augmented Generation (RAG) and AI agent system to:
   Generate dynamic queries to retrieve data through multiple AI-generated steps
   Correlate data identities between inconsistently set up systems of record
   Perform real-time data harmonization using generative AI techniques
Provide processed and harmonized data to plant operators with verification steps
Store AI-generated queries, correlation rules, and harmonization techniques in a dynamic knowledge base
Adapt the system in real-time based on feedback and changing conditions
Implement a natural language interface for intuitive operator interactions
Generate explanatory visualizations of complex data relationships and processing steps
Maintain an audit log of all system actions and operator interactions
Integrate with existing plant safety systems
Assess and report on efficiency gains and error reductions compared to traditional approaches

The harmonization of the data may be performed by:
Identification of semantic similarities between differently labeled data points
Automatic generation of mapping rules to standardize data nomenclature
Creation of a unified data schema that evolves with changing plant configurations

The system may include a multi-agent architecture, including any of the following:
A query generation agent
A data retrieval agent
A harmonization agent
An explanation agent
A coordination agent
One or more 3^{rd} party agents

In an embodiment, the natural language interface may include multi-lingual support, context-aware query interpretation, and the ability to handle follow-up questions and clarifications. The inquiry can be in any language, but the answer is based on the same data translated back into the inquiry language. Inquiries are prepended with prior conversation to provide full context. By way of example and not limitation, a user may ask in French, “Quels sont les derniers relevés de télémétrie pour le capteur de pression du réservoir A?” (“What are the latest telemetry readings for the pressure sensor in tank A?”). The system retrieves the relevant telemetry data, translates the response into French, and delivers it accordingly. If the user then follows up with “Y avait-il des alarmes associées?” (“Were there any associated alarms?”), the system uses the prior query to maintain context and responds with alarm data linked to the same sensor, again in French.

In an embodiment, the system may be used for predictive maintenance by:
Implementing a machine learning model to predict potential system failures or anomalies
Provide proactive maintenance recommendations to operators
Continuously update and refine the model using new operational data and outcomes
   This is achieved by continuously enriching data with labels, classifications, and anomaly scores for AI-assisted operations. It incorporates a broad blend of data science techniques:
Traditional ML: failure prediction, anomaly detection, optimization
Graph data science: alarm clustering (Louvain), single points of failure (betweenness centrality)
LLMs and transformers: entity resolution, natural language heuristics

As an example of the interactions of the techniques described above, imagine that a vibration sensor on a pump shows rising anomaly scores. Graph analysis links it to clustered alarms across nearby devices. An LLM interprets a technician's query and retrieves a similar past incident, prompting a proactive maintenance alert. The Digital AI Assistant sends the alert to the user and/or automatically sends instructions to other systems.

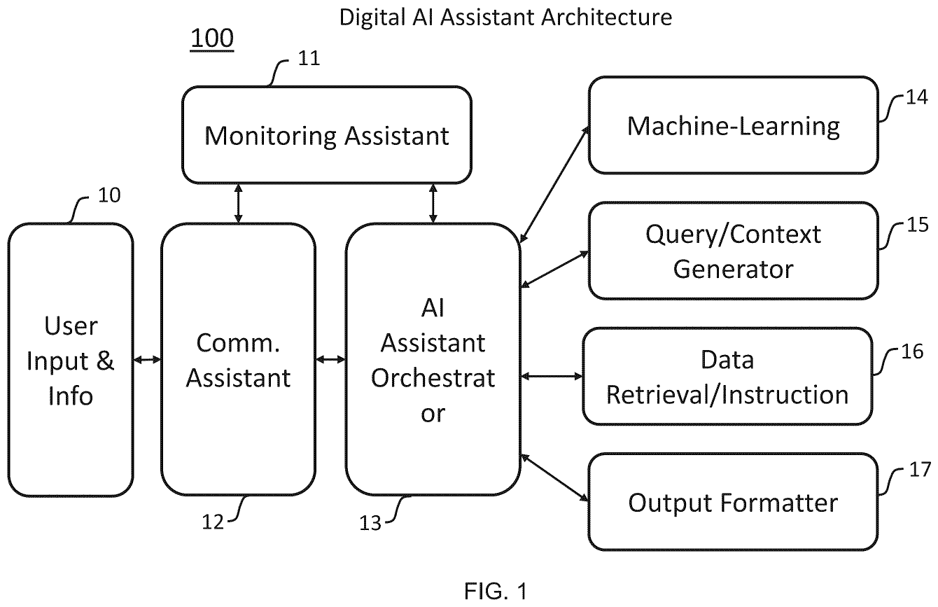

The methods and systems of the present disclosure may be implemented by a system and/or in a system, such as a system 100 shown in FIG. 1. The user input and information 10 includes the user's query, which can be made through any interface such as a chatbot or tool like Microsoft Teams. The user input and information 10 can be entered using colloquial language, allowing the user to make their request without any prescribed format or language. The user input and information 10 may further include information about the user's profile, including the types of data they may access, the data security level they may access, and the role they hold such as a technical developer, team leader, manager, or the like. The user's profile component captures essential user information, including location, organizational affiliations, roles, and more. This data serves multiple purposes, including determining user access to secure information and customizing search results to match user preferences. Users can fine-tune their search results by adding or removing content related to specific query topics. Additionally, users can set up personalized notifications or actions based on their natural language queries. In an embodiment, the user may use voice commands to submit queries. In another embodiment, the user may submit written queries. The user may use a combination of voice and written queries. Both written and voice queries may be in whatever language the user prefers and the response may be returned in the language of the query or based on a user preference.

One component of system 100 is the Communication (Comm.) Assistant 12. This service facilitates the connection between the Digital AI Assistant and specific applications like Teams or Digital Twin which are used for user input and information 10. It acts as a bridge, linking the application to the Digital AI Assistant Orchestrator 13 and, in turn, the Machine-Learning component 14, the Query/Context Generator component 15, the Data Retrieval/Instruction component 16, and the Output Formatter 17. The Communication Assistant 12 integration enables users to seamlessly interact with the Digital AI Assistant within the applications they are already familiar with.

The AI Assistant Orchestrator 13 uses the Machine-Learning component 14, particularly Large Language Models (LLMs), to identify topics within user queries. It employs generative AI and configurable heuristic rules to determine one or more topics. Once identified, the orchestrator manages the retrieval of search results for each topic by coordinating search and retrieval plugins. The AI Assistant Orchestrator 13 is fully aware of all of the capabilities of the AI agents within the system 100 and for the multiple disparate systems of record including security, data structures, and communication protocols. The AI Assistant Orchestrator 13 automatically generates requests for the AI agents and queries for the multiple disparate systems of record in their respective correct format and execution order including adaptive calls based on information for preceding request or execution steps. The AI Assistant Orchestrator 13 is configured to maintain comprehensive awareness of the operational capabilities of each AI agent within system 100, as well as across multiple disparate systems of record, including but not limited to security frameworks, data structures, and communication protocols. For example, the orchestrator is programmed to identify the specific data types each agent is capable of producing, the required input formats or parameters for agent activation, the appropriate communication protocols for interfacing with each agent, and the mechanisms for securely impersonating user credentials when necessary to access protected resources. Based on this capability profile, the orchestrator dynamically selects the most appropriate agent or combination of agents to fulfill a given data request, and constructs an optimized execution chain to derive the target output. If the orchestrator determines that additional contextual information is required to complete the request, it initiates a query to the user to obtain the necessary input. This orchestration process enables intelligent, secure, and efficient coordination among heterogeneous agents and systems to deliver accurate and contextually relevant responses, with the live, up-to-date information being accessed in-situ from the systems of record.

The AI Assistant Orchestrator 13 bridges the gap between user queries received through the Communication Assistant 12 from the User Input & Information 10 and the Data Retrieval/Instruction component 16. It translates user queries, expressed in natural language, into appropriate query languages specific to the various data sources. By doing so, it retrieves search results that match the user's intent. Moreover, this component ensures that the user's access adheres to the data security scheme of the source systems. The AI Assistant Orchestrator 13 leverages a hybrid data harmonization framework combining a structured knowledge graph with semantic embedding models to unify data across disparate systems of record. The knowledge graph, maintained by a dedicated harmonization pipeline, encodes definitive entity relationships and schema mappings, enabling precise cross-system linkage. While embedding models support approximate semantic matching, the orchestrator prioritizes the knowledge graph's authoritative relationships when conflicts arise. This override mechanism ensures that agent workflows are grounded in verified data linkages, reducing hallucinations and improving the accuracy and reliability of generated responses.

The Communication Assistant 12 and the AI Assistant Orchestrator 13 are also monitored by Monitoring Assistant 11. The Monitor Assistant 11 component functions as an autonomously within the Digital AI Assistant framework, enabling continuous, proactive surveillance of operational conditions. Upon receiving a user query, such as checking for critical alarms in a designated area, the Monitoring Assistant 11 can schedule recurring evaluations at defined intervals (e.g., every five minutes) to detect threshold breaches, elapsed time violations, or approaching critical states. If a relevant condition is identified, it immediately notifies the user via configured channels such as Teams, email, SMS, etc. In the absence of user response, the system initiates escalation protocols, routing the alert to higher levels of the process flow to ensure timely resolution and operational safety.

The Query/Context Generator 15 and the Data Retrieval/Instruction component 16 are the heart of the Digital AI Assistant's content search capabilities. The Query/Context Generator 15 determines the appropriate query or instructions that need to be sent to specific systems of record in order to retrieve the data requested by the user. The Data Retrieval/Instruction component 16 performs searches across various formats of enterprise content, both structured (like databases) and unstructured (like documents). It then processes and presents the search results in summarized or contextualized forms.

The Output Formatter 17 acts to present the retrieved data to the user in a coherent and understandable manner. This component handles the formatting of the search results, which can vary widely. The output may include raw data in formats like CSV or documents, as well as refined, contextualized summaries that consider the user's query and historical conversation. These refined answers can also be customized for specific target audiences based on the user's persona/profile. In some embodiments, the search Output Formatter 17 may also report a detailed log of the steps taken for verification purposes.

The Digital AI Assistant described herein has several key differentiators over other methods:
The Digital AI Assistant leverages generative AI from LLMs to dynamically generate code for searching content across various formats and source systems. This innovative approach allows the Assistant to adapt to changes in the data structure of source systems without requiring manual intervention from developers. In essence, conventional methods perform indexing of the data, requiring that the data from the multiple systems be ingested and indexed to generate a static dataset that is then queried. Unlike conventional methods, the Digital AI Assistant can directly access data from source systems without the need for copying or indexing data. This enables real-time content retrieval, eliminating the necessity for pre-indexing or pre-training the source system data. There is no need for pre-ingestion and curation of data from any/all of the systems of record before retrieval.
The Digital AI Assistant understands the user's security level and operational role, allowing it to only output data that the user is permitted to access. The output is also formatted such that it is optimally useful for the user's operational role. This means that a technical developer would receive results with more technical detail while a manager would receive output with a higher-level, broader view.

By combining these components and unique differentiators, the AI Assistant provides a sophisticated and user-friendly solution for enterprise content search, making it more efficient, adaptable, and intuitive for users across different roles and contexts.

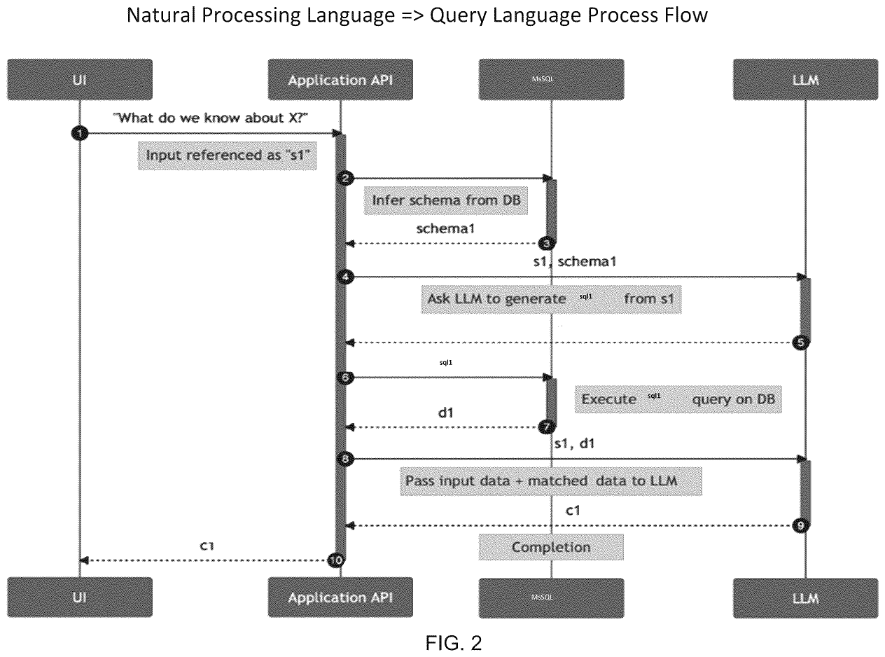

FIG. 2 illustrates an example process flow for using an LLM to prepare a search query and return a response, as would be implemented by system 100, based on allowing natural language queries from the user. This process flow can be used for both unstructured and structured content searches.

To facilitate natural language queries on unstructured content, the Large Language Model (LLM) implements the following basic techniques:
Text/Vector Embedding: This technique translates similar words into a universal machine representation or vocabulary, mitigating the need for precise word matching by employing a universal vocabulary. Sentences and paragraphs are stored as vector representations of this universal vocabulary, enabling easy matching of sentences/paragraphs with similar vector representations.
Vector Math: This method identifies sentences with similar meanings through vector representations (Cosine Similarity) and word distances (Euclidean distance). This allows the search engine to retrieve documents with the closest vector representation, accompanied by a confidence level.
Approximate Nearest Neighbor: This indexing technique uses approximate algorithms to find the M closest points in an N-dimensional vector space, instead of using a brute force approach that requires calculating the distance between all points in the vector space and the reference point. ANN, in conjunction with vector embedding, enables the search for similar vector representations in a vast amount of unstructured content within milliseconds.

To facilitate natural language queries on structured content, Generative AI and LLM will be employed to perform a series of transformations aimed at generating queries that yield precise and meaningful results. As a first step, the natural language inquiry needs to be converted to a source system (system of record) query language. Generative AI and LLM is used to translate natural language inquiries into query language for various structured source systems (e.g., MSSQL, Neo4j, REST) using prompt engineering techniques such as zero shot of few shots prompts training.

The next step translates the user query reference values into source system reference values. Most structured content databases index their data using B-TREE, inverted full-text index, etc. They rely on exact match instead of similarity match like vector indexes. While structured content databases offer fuzzy search functionalities (e.g., Neo4j has apoc.text.fuzzyMatch, apoc.text.levenshteinSimilarity, apoc.text.sorensenDiceSimilarity, etc. and MSSQL has soundex), they have limited or no index support for fuzzy searches and may result in full table scan. To leverage source system indexes, Generative AI is used to translate user-supplied reference values into the actual source system reference values. For clarity and ease of maintenance, an embodiment may implement the reference value translation in a modular component, rather than combining it with the query generation component. This allows the translation implementation and mapping rules to be customizable without impacting the query translation logic.

If users search for records with provided entity key/tag values, it is essential to ensure that entity key/tag values are translated into source system entity key/tag values. Unlike reference value translation mappings, which are more static and finite, the source system key/tag translation may involve intricate logic, including formatting conventions, anomaly overrides, and more. Furthermore, as new records are introduced into the source system, it may become necessary to update the logic to ensure that the new key/tag values undergo correct translation. For clarity and ease of maintenance, it is advisable to implement the key/tag value translation in a modular component, rather than combining it with the query generation component. This component could accept a query as input and return a query with entity key/tag values as output. Alternatively, in another scenario, each source system would manage standardized entity keys/tags, streamlining the process of linking related records. However, since we may not have control over the source system, modifying its data structure is not advisable.

The standard approach involves integrating multiple source systems into a master data store, also known as entity resolution. This resolves issues related to mismatched entity keys and inconsistent data structures. Nevertheless, it's a complex solution that demands significant implementation effort. It's worth noting that unstructured search using Large Language Models (LLM) implements vector embeddings and stores them in a master vector database, similar to the master data store concept.

A simpler alternative is to create and maintain mappings between source system values and standard reference values, including entity key/tags. This approach resolves the challenge of querying data from multiple source systems with varying key values, but it does not address issues related to mismatched entity models.
Reference data mapping: Mapping source system reference values to standard reference values.
Entity key mapping: Mapping source system entity keys/tags to standard entity keys/tags.

We can employ LLM to suggest initial mappings, along with their confidence levels. Human approvers can automatically accept suggestions with a high degree of confidence, while suggestions with a low degree of confidence can be manually processed. Once mappings receive approval, no further action is necessary.

Furthermore, we can continuously monitor the source system to identify new reference values or entity keys/tags, subjecting them to the same LLM algorithm. Approvers will only receive notifications if the matching falls below the confidence threshold.

With the mappings in place, translation can be performed in one pass or two pass, depending on the user-provided input value. Below are two scenarios illustrating how user-provided values are transformed into specific source system values.

### One-Pass Mapping

In this scenario, the user has provided a standard value in the query. The standard value can be directly converted into the corresponding actual value in the source system.

### Two-Pass Mapping

In this scenario, the user has supplied a value specific to the source system in the query. In such cases, we must first translate the source system value into the standard value and then proceed to translate the standard value into the specific source system value.

Handling disparate source systems is a complex problem that requires substantial effort.
For structured content search, implementing a master data store is simpler because the data model and values are normalized. With Generative AI, adding mappings for reference and entity key/tags doesn't require significantly more effort.
For unstructured content search using LLM, a similar issue arises because there's no guarantee that related reference values or entity keys/tags will generate the same vector embedding representation. By introducing mappings for reference and entity key/tags, a few straightforward adjustments to indexing and search processing can address this problem:
   Modify the vector embedding/indexing step to look up standard values in the mappings and embed/index additional standard values with the text. This enables searches using the standard value.
   Adjust the vector embedding of the search text to match the standard value for reference and entity key/tag before conducting the search. As LLM technology advances, additional enhancements such as Named Entity Disambiguation may reduce the need for the standard value mapping translation and instead allow LLM to identify similar values based on actual usage patterns.

The next step addresses the data level security.
For structured content, if the source system incorporates data-level security within the query, we can extend this logic to the generated query. Another approach is to invoke a registered function application owned by the source system's data owner to apply security patch logic to the generated query. In the case of the most prevalent data-level security implementation involving user role claims+record role claim stamp, a generic implementation can be achieved by querying the user's role claims and subsequently only retrieving records falling within the scope of their role claim authority.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, the processor may be configured to execute one or more additional computer program components that may perform some or all of the functionality attributed to one or more of computer program components described herein.

The system may be enhanced with the following:

### 1.1 User-Level Security

Apply user-level security for all RAG-generated queries across multiple systems of record, both structured and unstructured:
   For structured and semi-structured systems (e.g., MSSQL, Azure Cosmos DB, Neo4j, ADX, REST, OData, GraphQL):
      Apply user's current login authentication token
      Utilize global application login with user impersonation
      Implement user-specific data custom security filters configured at each system of record level
   For unstructured content queries (e.g., Azure Cognitive Search, vector database search):
      Return only search results accessible to the current user
      Implement security at Azure Entra level using users, security groups, and claims
      Tag protected/sensitive documents with custom security claims
      Eliminate search results for documents the user lacks proper claims to access

### 1.2 Enhanced AI Agent Orchestration and Reasoning

Support multiple orchestration paths and multiple returned answers:
   Determine a preferred orchestration path heuristically for the main answer
   Allow users to select alternate answers
   Implement a weighting system to adjust preferred paths based on user selections over time
Improve the AI data harmonization engine for inconsistent data identities:
   Incorporate human-in-the-loop feedback weighting
   Introduce a facility knowledge graph as a system of reference to reduce repeated dynamic processing
   Implement enhanced AI entity resolution to convert paper P&IDs to digitized P&IDs
   Utilize the facility knowledge graph as a navigation tool to connect data between disparate systems

### 1.3 Answer Output Profiling

Enhance the final answer output to support different answer profiles based on user roles:
   For facility operators:
      Curate answers in facility operator language or Alarm Operation Action (AoA) language
      Provide less detail to prevent information overload during alarm flooding events
   For engineers:
      Curate answers with more technical details
      Include steps to derive the answer for further processing or verification

In an embodiment, the system may be designed for retrieving data related to hydrocarbon exploration, production, and/or refining.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A system for secure data retrieval from multiple disparate systems of record using Artificial Intelligence (AI), the system comprising: one or more physical processors configured by machine-readable instructions to:
a. receive input from an operator;
b. based on the input from the operator, retrieve live data from the multiple disparate systems of record using a retrieval-augmented generation (RAG) approach, AI agents, and an AI Assistant Orchestrator, wherein the AI Assistant Orchestrator is aware of all of capabilities of the AI agents and the multiple disparate systems of record including security, data structures, and communication protocols, and wherein the AI Assistant Orchestrator automatically generates requests for the AI agents and queries for the multiple disparate systems of record in their respective correct format and execution order including adaptive calls based on information for preceding request or execution steps;
c. correlate data identities between the multiple disparate systems of record and the AI agents using dynamically generated harmonization steps with generative AI to obtain retrieved data and correlated information; and
d. provide the retrieved data and the correlated information to the operator.

2. The system of claim 1, wherein the one or more physical processors are further configured by the machine-readable instructions to dynamically generate harmonization steps using generative AI to ensure data consistency across different systems of records.

3. The system of claim 1, wherein the one or more physical processors are further configured by the machine-readable instructions to provide a verification interface for the operator to review steps taken to retrieve and correlate the retrieved data.

4. The system of claim 1, wherein the retrieval-augmented generation (RAG) approach includes:
a. generating and executing queries to retrieve data from the multiple disparate systems of records;
b. dynamically adjusting the queries based on intermediate results to ensure accurate data retrieval.

5. The system of claim 1, wherein the AI agent is configured to:
a. identify and resolve inconsistencies in the data identities between the multiple disparate systems of record; and
b. harmonize the retrieved data using generative AI techniques to ensure consistency and accuracy.

6. The system of claim 1, wherein the system does not perform pre-ingestion and curation of data from all systems of records before retrieval.

7. The system of claim 1, wherein the AI agent is configured to:
a. identify user profile information including security level and operational role; and
b. provide only the retrieved data within the security level, formatted to be understood according to the operational role.

8. The system of claim 1, wherein one of the AI agents is a monitoring assistant.

9. The system of claim 1, wherein one of the AI agents is a communications assistant.
